(19) United States
(12) Patent Application Publication
(10) Pub. No.: US 2016/0056994 A1
(43) Pub. Date: Feb. 25, 2016

(54) Diagnosing Network Misconfiguration Externally

(71) Applicant: MICROSOFT CORPORATION, Redmond, WA (US)

(72) Inventors: Mike Cales, Redmond, WA (US); Scott McMurray, Redmond, WA (US); Jacob Pitts, Sammamish, WA (US)

(73) Assignee: MICROSOFT CORPORATION, Redmond, WA (US)

(21) Appl. No.: 14/464,702

(22) Filed: Aug. 20, 2014

(51) Int. Cl. H04L 12/24; H04L 12/26

(52) U.S. Cl. CPC H04L 41/0654; H04L 43/0847; H04L 43/065

(57) ABSTRACT

In one embodiment, a network service client 112 may provide connectivity data 420 about a failed network connection attempt 300 to a network service 120 upon a later connection. The network service client 112 may register a failed network connection attempt 300 to a network service 120. The network service client 112 may successfully connect to the network service 120. The network service client 112 may automatically report connectivity data 410 related to the failed network connection attempt 300.

### BACKGROUND

A network service may provide a data service accessible by multiple users via a data network. The data service may be file storage, communications, software as a service, and other computing tasks. The network service may be maintained by a server farm, or a set of one or more servers operating in concert to implement the network service. The network service may depend on a network provider to connect a network service client to the network service.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a network service client providing connectivity data about a failed network connection attempt to a network service upon a later connection. The network service client may register a failed network connection attempt to a network service. The network service client may successfully connect to the network service. The network service client may automatically report connectivity data related to the failed network connection attempt.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a data network.

FIG. 2 illustrates, in a block diagram, one embodiment of a computing device.

FIGS. 3a-b illustrates, in a block diagram, one embodiment of a network connection attempt.

FIG. 4 illustrates, in a block diagram, one embodiment of a connectivity failure report.

FIG. 5 illustrates, in a block diagram, one embodiment of a connectivity history record.

FIG. 6 illustrates, in a block diagram, one embodiment of a connectivity fix report.

FIG. 7 illustrates, in a flowchart, one embodiment of a method for resolving a failed network connection attempt at a network service client.

FIG. 8 illustrates, in a flowchart, one embodiment of a method for resolving a failed network connection attempt at a network connectivity monitor.

FIG. 9 illustrates, in a flowchart, one embodiment of a method for resolving a failed network connection attempt at a network provider.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a network connectivity monitor.

A network connectivity monitor may detect when a user is unable to connect to a network service. The network connectivity monitor may factor that information with the geo-location and other limited network information across the multiple users in the user base to detect users that are trying to connect from various locations that are misconfigured. In the cases of widely used public WiFi® networks, such as hotels, airports, and other public networks, the network connectivity monitor may track and notify users upon re-establishing a connection the true source of the connectivity issues, such as the network provider. For large numbers of impacted users, the network connectivity monitor may contact the network provider to help resolve the issue.

Thus, in one embodiment, a network service client may provide connectivity data about a failed network connection attempt to a network service upon a later connection. The network service client may register a failed network connection attempt to a network service. The network service client may successfully connect to the network service. The network service client may automatically report connectivity data related to the failed network connection attempt. A network connectivity monitor may automatically receive from a network service client connectivity data related to a failed network connection attempt to a network service. The network connectivity monitor may automatically decipher the client connectivity data to determine a potential cause of the failed network connection attempt.

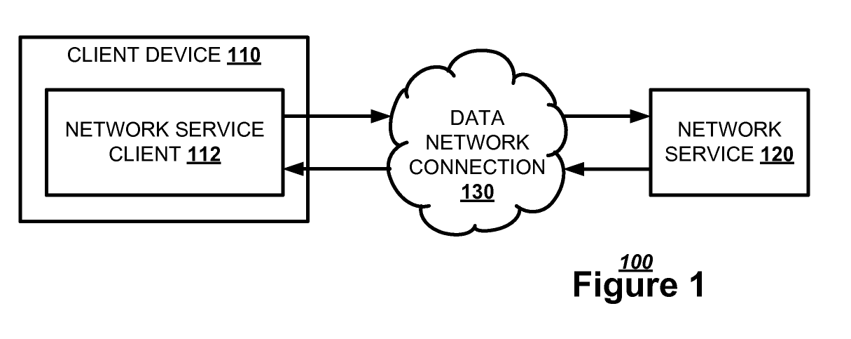

FIG. 1 illustrates, in a block diagram, one embodiment of a data network 100. A client device 110 may execute a network service client 112 to connect to a network service 120 via a data network connection 130. The network service client 112 may be a separate application or integrated into an operating system or an internet browser platform. The network service 120 may refer to a single server or a distributed set of servers that may access the cloud data set, such as a server farm. The data network connection 130 may be an internet connection, a wide area network connection, a local area network connection, or other type of data network connections.

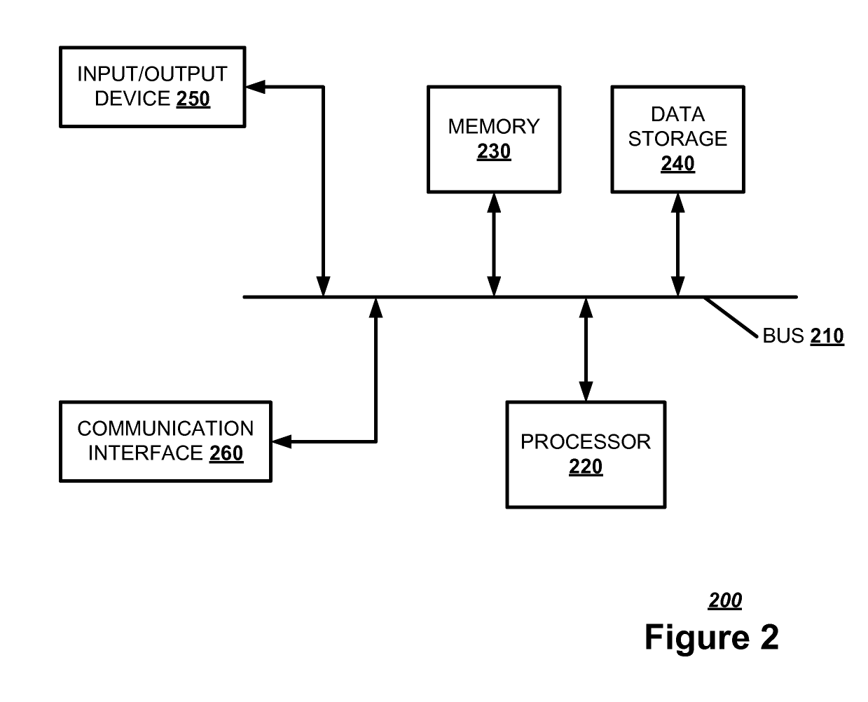

FIG. 2 illustrates a block diagram of an exemplary computing device 200 which may act as a client device 110 or a network service 120 server. The computing device 200 may combine one or more of hardware, software, firmware, and system-on-a-chip technology to implement a client device 110 or a network service 120 server. The computing device 200 may include a bus 210, a processor 220, a memory 230, a data storage 240, an input/output device 250, and a communication interface 260. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic data storage that stores information and instructions for execution by the processor 220. The memory 230 may also store temporary variables or other intermediate information used during execution of instructions by the processor 220. The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing a connectivity history or a connectivity issue hotspot list.

The input/output device 250 may include one or more conventional mechanisms that permit a user to input information to the computing device 200, such as a keyboard, a mouse, a voice recognition device, a microphone, a headset, a gesture recognition device, a touch screen, etc. The input/output device 250 may include one or more conventional mechanisms that output information to the user, including a display, a printer, one or more speakers, a headset, or a medium, such as a memory, or a magnetic or optical disk and a corresponding disk drive. The communication interface 260 may include any transceiver-like mechanism that enables computing device 200 to communicate with other devices or networks. The communication interface 260 may include a network interface or a transceiver interface. The communication interface 260 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

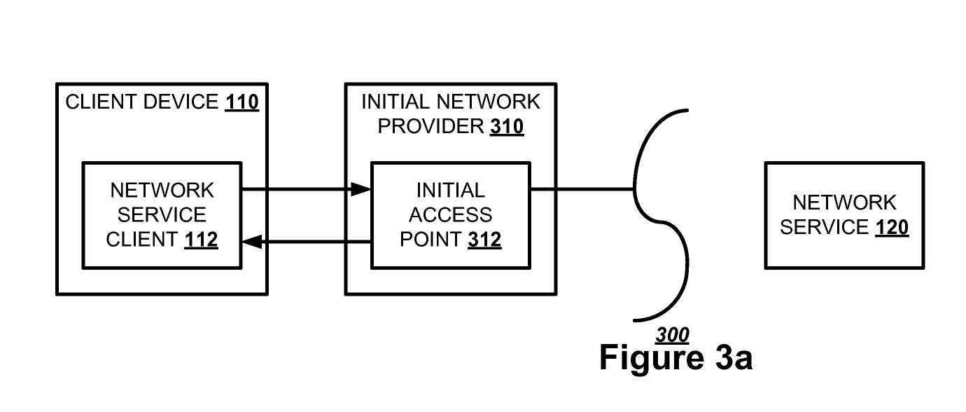

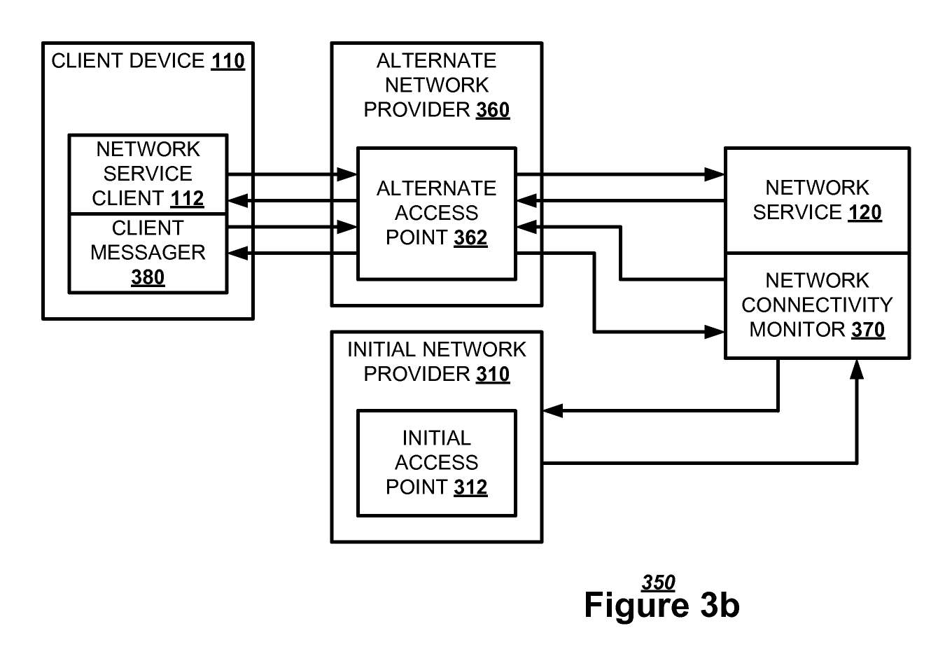

In order to interact with a network service 120, the network service client 112 may first have to connect with the network service 120 via a network. FIG. 3a illustrates, in a block diagram, one embodiment of a failed network connection attempt 300. A network service client 112 operating on a client device 110 may attempt to connect to the network service 120 via an initial network maintained by an initial network provider 310. The network provider 310 may be an internet service provider, local area network provider, mobile carrier, or other data network provider. The network provider 310 may provide an initial access point 312 for the network service client 112 to access the network. If the network connection attempt fails, the network service client 112 may register the failed network connection attempt for later reporting. A failed network connection attempt 300 may be an attempt that provides no connection or an attempt that provides a connection that grossly fails to meet service standards.

FIG. 3b illustrates, in a block diagram, one embodiment of a successor network connection attempt 350. The network service client 112 may seek out an alternate communication option to connect to the network service 120. The network service client 112 may attempt to connect to the network service 120 via a successor network maintained by an alternate network provider 360. The alternate network provider 360 may provide an alternate access point 362 for the network service client 112 to access the network. Alternately, the initial network provider 310 may maintain the alternate access point 362.

Once a connection has been established between the network service client 112 and the network service 120, the network service client 112 may automatically report client connectivity data to a network connectivity monitor 370. The network connectivity monitor 370 may use the client connectivity data to determine the cause of any network connectivity issues. By identifying the cause of the network connectivity issues, the network connectivity monitor 370 may inform a user of the true source of any network connectivity issues and search for a solution to prevent future occurrences. The network connectivity monitor 370 may be integrated into the network service 120 or a separate entity in communication with the network service 120.

The network service client 112 may allow a user to opt out of sending the client connectivity data to the network connectivity monitor 370 or request a user to opt in before sending. Additionally, the network service client 112 may anonymize the client connectivity data by removing any user personal information. The network service client 112 may prepare a pre-populated message containing the connectivity failure report to present a user for approval before sending using a client messenger application 380.

Once the network connectivity monitor 370 has been alerted to a failed network connection attempt 300, the network connectivity monitor 370 may request further data from the network service client 112. Additionally, the network connectivity monitor 370 may query the initial network provider 310 for any network-side connectivity data relating to the failed network connection attempt 300. The network connectivity monitor 370 may maintain a connectivity history for the network service client 112 or the network provider 310. The connectivity history may describe previous network connection attempts by the network service client or previous network connection attempts at that access point 312. The network connectivity monitor 370 may anonymize any user personal information received in a connectivity failure report. The network connectivity monitor 370 may factor in the network-side connectivity data, any ancillary connectivity data from an ancillary network service client, and the connectivity history. An ancillary network service client is a different network service client than the network service client that sent the client connectivity data.

The network connectivity monitor 370 may prepare a connectivity fix report to send to the network service client 112 and to the network provider 310. The connectivity fix report may identify the connection failure source that caused the failed network connection attempt 300. The network service client 112 may present the connectivity fix report to the user, so that the user is made aware of the cause of any failed network connection attempt 300. The connectivity fix report may also describe possible solutions to the failure of the network connection attempt or alternate networks for the client device 110 to connect to the network service 120. The network connectivity monitor 370 may provide the connectivity fix report to any ancillary network service clients that also experienced these connectivity issues.

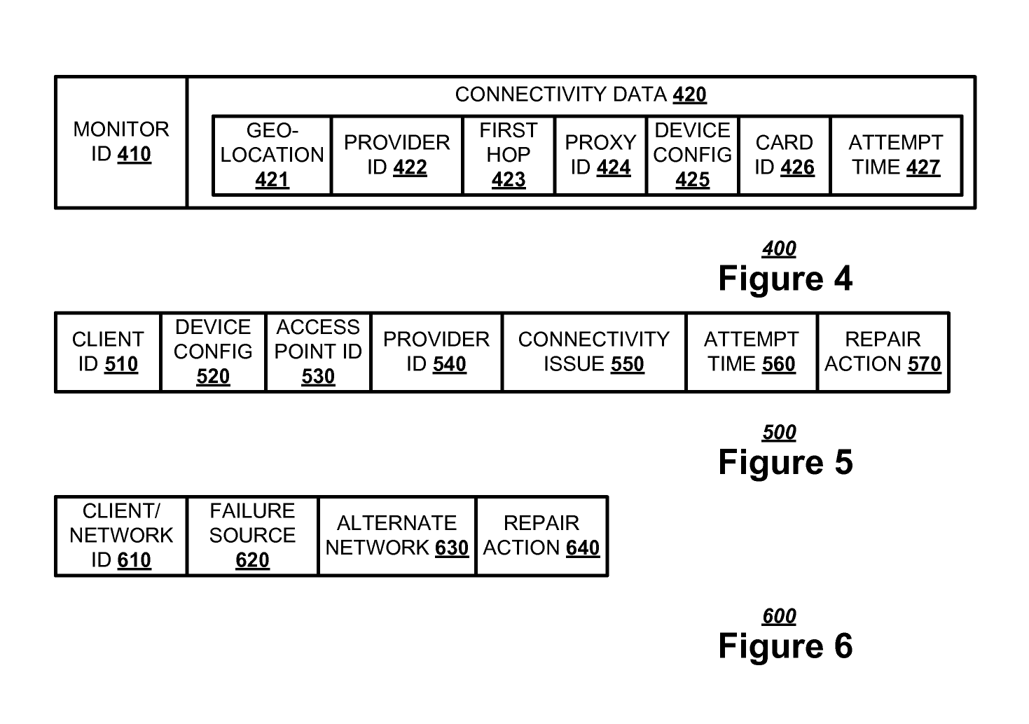

FIG. 4 illustrates, in a block diagram, one embodiment of a connectivity failure report 400. The connectivity failure report 400 may have a network connectivity monitor identifier (ID) 410 identifying the network connectivity monitor 370 associated with that network service 120. The connectivity failure report 400 may have connectivity data 420 describing the circumstances surrounding a failed network connection attempt 300.

The connectivity data 420 may be the geo-location 421 of the connection attempt, a network provider identifier 422, a first hop data set 423, a proxy agent identifier 424, a device configuration 425, a network card identifier 426, and an attempt timestamp 427. The network service client 112 may determine the geo-location 421 of the connection attempt based on global positioning system data or on the internet protocol address of the initial access point 312. The network provider identifier 422 identifies the initial network provider 310 that maintains the initial access point 312 that was the site of the failed network connection attempt 300. A first hop data set 423 describes the first hop, or first leg, of the transmission path between the network service client 112 and the network service 120. A proxy agent identifier 424 may identify a proxy agent used to communicate between the network service client 112 and the network service 120. A device configuration 425 describes the configuration of the client device 110. A network card identifier 426 describes the network card used as a communication interface 260 in the client device 110. An attempt timestamp 427 describes the time of the failed network connection attempt 300.

FIG. 5 illustrates, in a block diagram, one embodiment of a connectivity history record 500. The connectivity history record 500 may have a client identifier 510 identifying the network service client 112 that executed the failed network connection attempt 300. The client identifier 510 may be a hash of the client identifier to preserve the anonymity of the user. The connectivity history record 500 may have a device configuration 520 describing the configuration of the client device 110. The connectivity history record 500 may have an access point identifier 530 identifying the access point 312 that was the site of a failed network connection attempt 300. The connectivity history record 500 may have a network provider identifier 540 identifying the initial network provider 310 that maintains the initial access point 312 that was the site of the failed network connection attempt 300. The connectivity history record 500 may have a connectivity issue array 550 describing any connectivity issues that may have arisen at that access point 312. The connectivity history record 500 may have an attempt timestamp 560 describing the connectivity issue 550 that arose. The connectivity history record 500 may have a connectivity repair action array 570 describing any connectivity repair actions for fixing the connectivity issue 550.

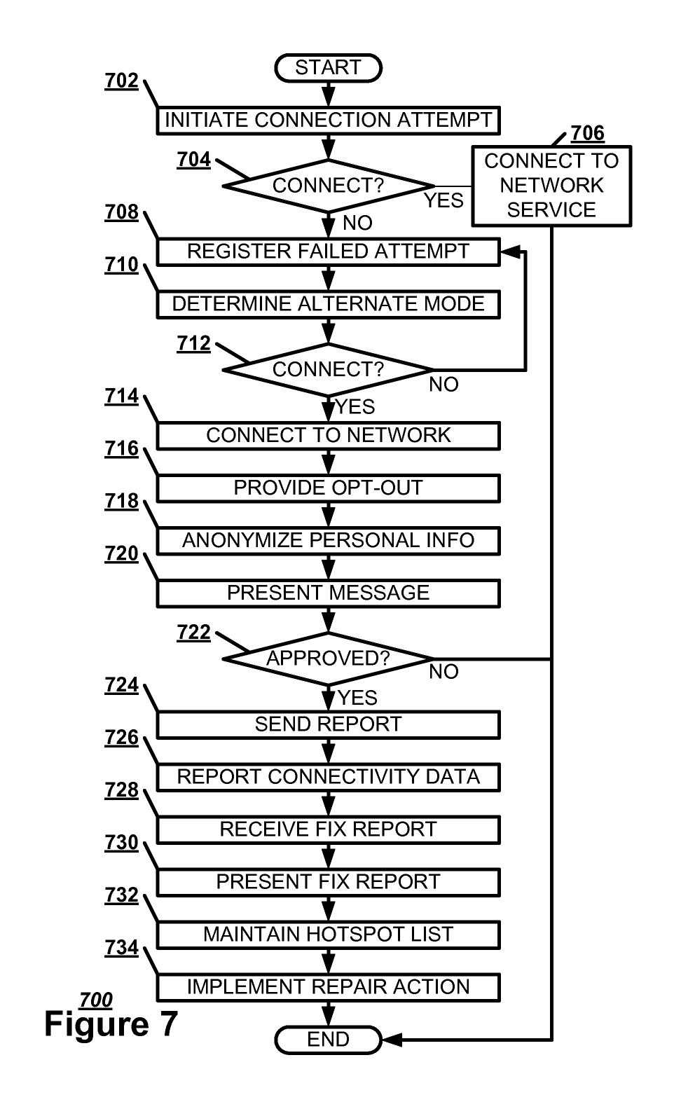

FIG. 6 illustrates, in a block diagram, one embodiment of a connectivity fix report. A connectivity fix report 600 may have a client identifier 610, or alternately a network identifier 610, indicating the target receiving the connectivity fix report 600. The connectivity fix report 600 may identify the connection failure source that prevented a successful connection attempt in a connection failure source field 620. The network service client 112 may present the connection failure source 620 to the user. The connectivity fix report 600 may describe an alternate network provider 360 in an alternate network provider field 630. The connectivity fix report 600 may describe a connectivity repair action for fixing the connectivity issue that caused the failed network connection attempt 300 in a connectivity repair action field 640.

FIG. 7 illustrates, in a flowchart, one embodiment of a method 700 for resolving a failed network connection attempt 300 at a network service client 112. The network service client 112 may initiate a network connection attempt at an access point 312 maintain by a network provider 310 (Block 702). If the network connection attempt succeeds (Block 704), the network service client 112 may connect to the network service 120 (Block 706). If the network connection attempt fails (Block 704), the network service client 112 may register a failed network connection attempt 300 to the network service 120 (Block 708). The network service client 112 may determine an alternate communication mode for sending a connectivity failure report (Block 710).

If the network connection attempt using the alternate communication mode succeeds (Block 712), the network service client 112 may successfully connect to the network service 120 (Block 714). The network service client 112 may provide an opt-out to a user (Block 716). The network service client 112 may anonymize user personal information in a connectivity failure report (Block 718). The network service client 112 may present a pre-populated message containing a connectivity failure report to a user for approval (Block 720). If the user approves (Block 722), the network service client 112 may send the connectivity failure report to the network connectivity monitor (Block 724). The network service client 112 may automatically report connectivity data 420 related to the failed network connection attempt 300 (Block 726).

The network service client 112 may receive a connectivity fix report indicating a connection failure source from the network connectivity monitor 370 (Block 728). The network service client 112 may present the connectivity fix report indicating the connection failure source to the user (Block 730). The network service client 112 may maintain a connectivity issue hotspot list (Block 732). The network service client 112 may implement a connectivity repair action described in the connectivity fix report (Block 734).

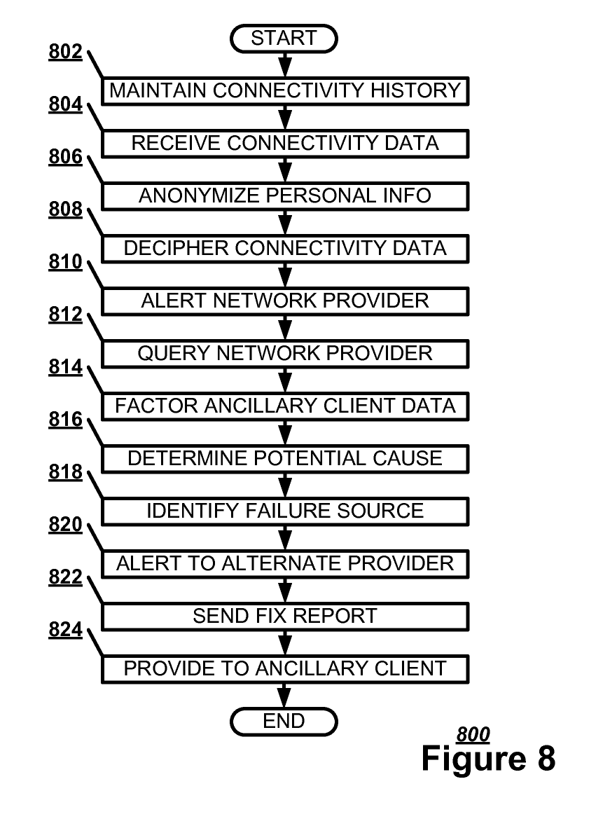

FIG. 8 illustrates, in a flowchart, one embodiment of a method 800 for resolving a failed network connection attempt 300 at a network connectivity monitor 370. The network connectivity monitor 370 may maintain a connectivity history (Block 802). The network connectivity monitor 370 may automatically receive from a network service 120 in a connectivity failure report 400 client connectivity data 420 related to a failed network connection attempt 300 to a network service 120 (Block 804). The network connectivity monitor 370 may anonymize user personal information received in the connectivity failure report 400 (Block 806). The network connectivity monitor 370 may automatically decipher the client connectivity data 420 to determine a potential cause of the failed network connection attempt 300 (Block 808).

The network connectivity monitor 370 may alert a network provider 310 of the failed network connection attempt 300 (Block 810). The network connectivity monitor 370 may query a network provider 310 for the failed network connection attempt 300 for network-side connectivity data (Block 812). The network connectivity monitor 370 may factor ancillary client connectivity data from an ancillary network service client into determining a potential cause of the failed network connection attempt 300 (Block 814). The network connectivity monitor 370 may determine a potential cause of the failed network connection attempt 300 based on client connectivity data 410, ancillary client connectivity data, network-side connectivity data, and connectivity history (Block 816).

The network connectivity monitor 370 may identify a connection failure source in a connectivity fix report (Block 818). The network connectivity monitor 370 may alert a network service client 112 to an alternate network provider 360 (Block 820). The network connectivity monitor 370 may send a connectivity fix report describing a connectivity repair action to at least one of a network service client 112 and a network provider 310 (Block 822). The network connectivity monitor may provide a connectivity fix report describing a connectivity repair action to an ancillary network service client (Block 824).

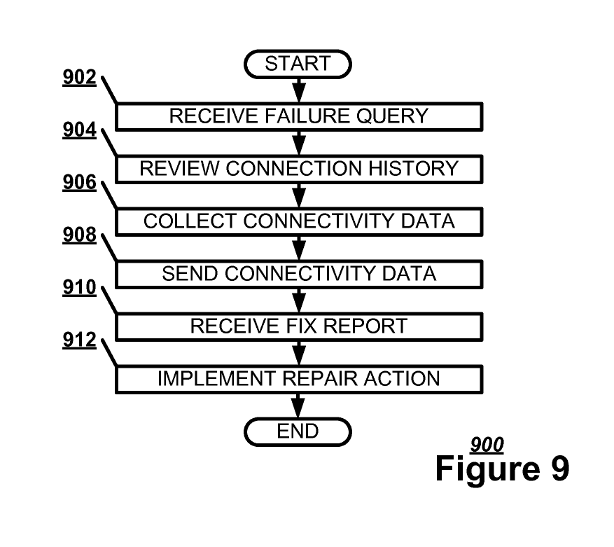

FIG. 9 illustrates, in a flowchart, one embodiment of a method 900 for resolving a failed network connection attempt 300 at a network provider 310. The network provider 310 receive a failure query from network connectivity monitor 370 (Block 902). The network provider 310 may review a connection history at the access point 312 (Block 904). The network provider 310 may collect network-side connectivity data for the access point 312 (Block 906). The network provider 310 may send the network-side connectivity data for the access point 312 to the network connectivity monitor 370 (Block 908). The network provider 310 may receive a connectivity fix report from the network connectivity monitor 370 (Block 910). The network provider 310 may implement a connectivity repair action described in the connectivity fix report (Block 912).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
receiving automatically from a network service client connectivity data related to a failed network connection attempt to a network service; and
deciphering automatically the client connectivity data to determine a potential cause of the failed network connection attempt.

2. The method of claim 1, further comprising:
anonymizing user personal information received in a connectivity failure report.

3. The method of claim 1, further comprising:
factoring ancillary client connectivity data from an ancillary network service client into determining a potential cause of the failed network connection attempt.

4. The method of claim 1, further comprising:
maintaining a connectivity history.

5. The method of claim 1, further comprising:
querying a network provider for the failed network connection attempt for network-side connectivity data.

6. The method of claim 1, further comprising:
alerting a network provider of the failed network connection attempt.

7. The method of claim 1, further comprising:
identifying a connection failure source in a connectivity fix report.

8. The method of claim 1, further comprising:
sending a connectivity fix report describing a connectivity repair action to at least one of a network service client and a network provider.

9. The method of claim 1, further comprising:
alerting a network service client to an alternate network provider.

10. The method of claim 1, further comprising:
providing a connectivity fix report describing a connectivity repair action to an ancillary network service client.

11. A tangible machine-readable medium having a set of instructions detailing a method stored thereon that when executed by one or more processors cause the one or more processors to perform the method, the method comprising:
registering a failed network connection attempt to a network service;
connecting successfully to the network service; and
reporting automatically connectivity data related to the failed network connection attempt.

12. The tangible machine-readable medium of claim 11, wherein the method further comprises:
maintaining a connectivity issue hotspot list at the network service client.

13. The tangible machine-readable medium of claim 11, wherein the method further comprises:
determining an alternate communication mode for sending a connectivity failure report.

14. The tangible machine-readable medium of claim 11, wherein the method further comprises:
presenting a pre-populated message containing a connectivity failure report to a user for approval.

15. The tangible machine-readable medium of claim 11, wherein the method further comprises:
anonymizing user personal information in a connectivity failure report.

16. The tangible machine-readable medium of claim 11, wherein the method further comprises:
providing an opt-out to a user of the network service client.

17. The tangible machine-readable medium of claim 11, wherein the method further comprises:
receiving a connectivity fix report indicating a connection failure source from a network connectivity monitor.

18. The tangible machine-readable medium of claim 11, wherein the method further comprises:
implementing a connectivity repair action described in a connectivity fix report.

19. A network connectivity monitor, comprising:
a communication interface that automatically receives client connectivity data from a network service client related to a failed network connection attempt to a network service; and
a processor that automatically deciphers the client connectivity data to determine a potential cause of the failed network connection attempt.

20. The network connectivity monitor of claim 19, wherein the client connectivity data has at least one of a geo-location of the connection attempt, a network provider identifier, a first hop data set, a proxy agent identifier, a device configuration, a network card identifier, and an attempt timestamp.
